(19) United States
(12) Patent Application Publication
(10) Pub. No.: US 2009/0022015 A1
(43) Pub. Date: Jan. 22, 2009

(54) Media Playable with Selectable Performers

(76) Inventor: Donald Harrison, New Orleans, LA (US)

Correspondence Address: NIXON & VANDERHYE, PC, 901 NORTH GLEBE ROAD, 11TH FLOOR, ARLINGTON, VA, 22203, US

(21) Appl. No.: 12/137,061

(22) Filed: Jun. 11, 2008

Related U.S. Application Data
(60) Provisional application No. 60/950,375, filed on Jul. 18, 2007.

(51) Int. Cl. G11B 20/00

(52) U.S. Cl. 369/1

(57) ABSTRACT

A media processor and method of customizing a media composition enables a user to compile a customized media file with selectable tracks. Each of the selectable tracks includes a recording of a performer performing a part of a particular composition, such as an instrument or vocal part in a musical piece. The user is provided an option to select one or more of the tracks; and a customized media file is prepared based on the user selected tracks.

### CROSS-REFERENCES TO RELATED APPLICATIONS

This application claims the benefit of U.S. Provisional Patent Application Ser. No. 60/950,375, filed Jul. 18, 2007, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

The invention relates to a media processor and software concept that allows a user to interchange various performances of actors, musicians, etc. on the same composition.

Talented musicians and performers may interpret, arrange or perform music in their own style. As such, a particular composition may have a considerably different sound when played by one group of performers as compared to another group of performers. A listener may appreciate varying styles of different vocalists and instrumentalists, and it would be desirable to provide a vehicle for the listener to select specific performers on a particular composition to create a custom performance. Actors similarly may interpret or perform certain scripts, scenes, movies, etc. in their own style, and a particular performance of one actor may have a different result as compared to another actor.

### SUMMARY OF THE INVENTION

The concept described herein allows a user to interchange various performances of individuals (i.e., musicians, vocalists, actors, etc.) on the same composition. Although the invention is applicable to any form of media including a performing artist, the description will primarily focus on music. In this context, songs are arranged and recorded so that each instrument has a number of players playing each part in their own unique way. For example, each track is provided with two or more drummers, guitarists, pianists, singers, etc. The user is able to choose between different vocalists and instrumentalists to create a custom performance of the composition.

In use, when the user puts a CD/DVD in the player or selects a digital file to play via a PC or the like, the user is provided with a list of performers and is prompted to make selections. Once all selections have been made, the user selects “play” to hear the music (final mix choice). It is possible in some instances to select two or more performers from the same instrument or two or more singers at the same time.

All of the tracks are preferably in digital format when played together by the system. The user has the ability to make as many file mix choices as each composition will allow. The user's custom final mix choice of the tracks can be available for transfer to other formats such as CD, MP3, etc. The format will also have the ability to add additional performers to all compositions that are not present when the first rendition of a composition is released.

In an exemplary embodiment, a method of customizing a media composition includes the steps of (a) providing a media file with selectable tracks, each track including a recording of a performer performing a part of a particular composition; (b) providing a user an option to select one or more of the tracks; and (c) preparing a customized media file based on the user selected tracks. The method may further include, prior to step (a), a step of recording the selectable tracks, wherein the selectable tracks of the particular composition are synchronized with one another. In this context, the recording step may be practiced by recording the selectable tracks in audio isolation with no audio leakage from other tracks.

The media file may comprise a music file, where step (a) is practiced by providing each track with a recording of a performer playing an instrument or performing a vocal part of the particular composition. In this context, step (a) may be further practiced by providing the music file with tracks including multiple performances of each instrument or vocal part.

The method may additionally include, after step (c), a step of enabling the user to preview the customized media file, and providing the user with an option to repeat steps (b) and (c). After step (c), the method may comprise finalizing the customized media file upon instruction by the user. Still further, the method may include storing the finalized customized media file in a format suitable for download, storage and playback.

In another exemplary embodiment, a media processor for customizing a media file includes a processor programmed to carry out a media customization process, and a memory communicating with the processor. The memory stores a media file with selectable tracks, each track including a recording of a performer performing a part of a particular composition. A user interface communicating with the processor enables a user to select one or more of the tracks. The processor is programmed to prepare a customized media file based on the user selected tracks.

In still another exemplary embodiment, a method of customizing a media composition includes the steps of (a) recording a plurality of media files for the media composition, the media files including digital media tracks synchronized with one another, each track including a recording of a performer performing a part of a particular composition; (b) providing a user an option to select one or more of the tracks; (c) combining the selected tracks into a customized media file; (d) enabling the user to preview the customized media file, and providing the user with an option to repeat steps (b) and (c); and (e) when prompted by the user, finalizing the customized media file based on the user selected tracks.

### BRIEF DESCRIPTION OF THE DRAWINGS

These and other aspects and advantages will be described in detail with reference to the accompanying drawings, in which:

FIG. 1 is a flowchart of the customized media processing method;

FIG. 2 is an exemplary screen shot in a software or Internet environment; and

FIG. 3 illustrates an exemplary front panel of a hardware application.

### DETAILED DESCRIPTION OF THE INVENTION

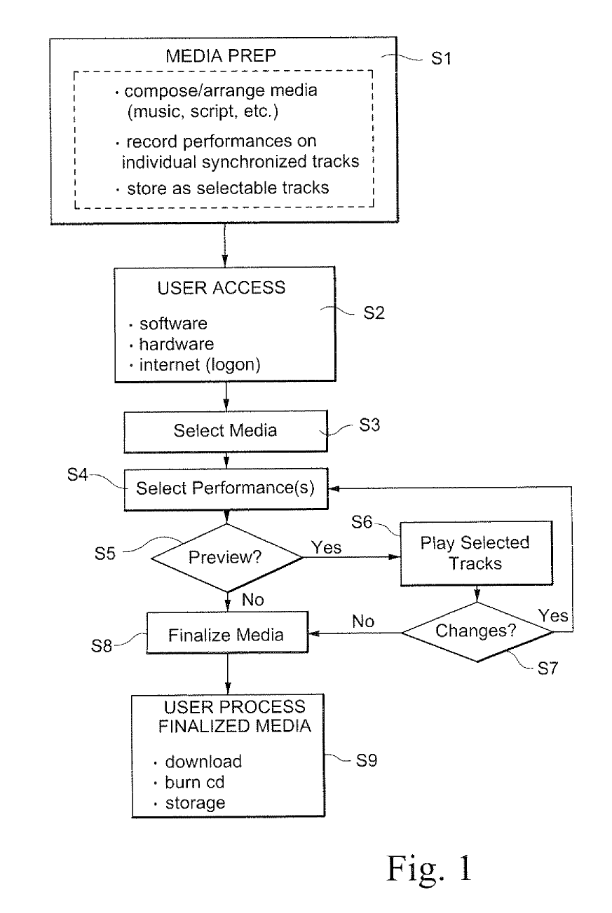

FIG. 1 is a flowchart illustrating the steps performed by a media processor for customizing a media file according to a preferred embodiment. In preparing the media (step S1), new media may be created, such as the composition of a song, writing a script, etc., or existing media may be arranged for processing by the described system. The arrangement includes separate parts for a plurality of performers. For example, in a music context, a song may include a plurality of parts for a number of instruments as well as one or more vocal parts. Multiple performances of each part, instrument, vocal performance, etc. represented in the arrangement are then recorded in a manner that they can be placed in alignment to all other parts of the arrangement. That is, performances are recorded in individual tracks that are synchronized with one another. Preferably, each part is recorded in audio isolation with no audio leakage from other tracks. The recorded performances are thus mixed and aligned so that one performance or multiple performances of each part, instrument, vocalist, etc. can be aligned together for multiple choice performance variations.

The tracks are subsequently stored or converted for use by the general public (users). Any suitable format can be used as would be appreciated by those of ordinary skill in the art. The format should be accessible via downloading from the Internet or via uploading from a CD, DVD or other data storage device. The tracks can be stored in a computer, telephone, handheld data storage device such as MP3 players or the like, or any present or future device for the manipulation and processing of data.

In step S2, the user accesses the system via any suitable means. In a computer environment, the user may download software via the Internet or from a CD, DVD or other data storage device for operation by a computer processor. The software may require an authorized key to allow the user access to a website to download media files such as song files or the like. Alternatively, the media files may be uploaded from a storage device. The manner of downloading and installing software to a user computer is well known, and details of the download/installation process will not be described.

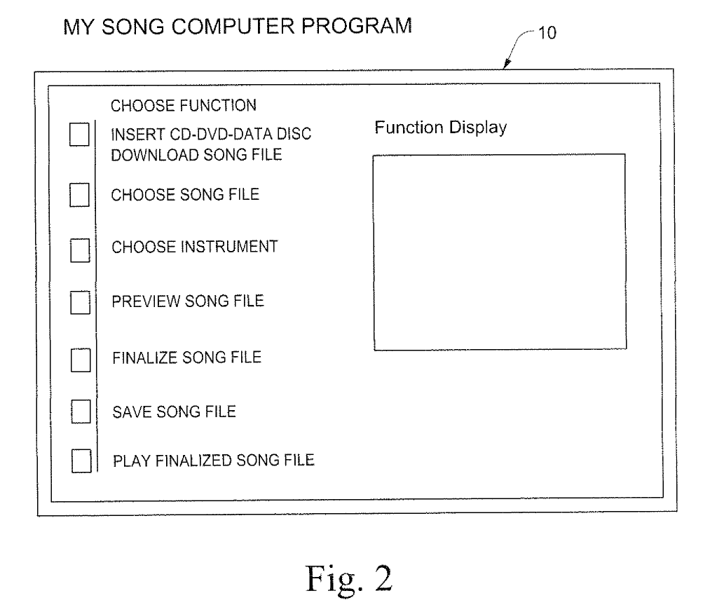

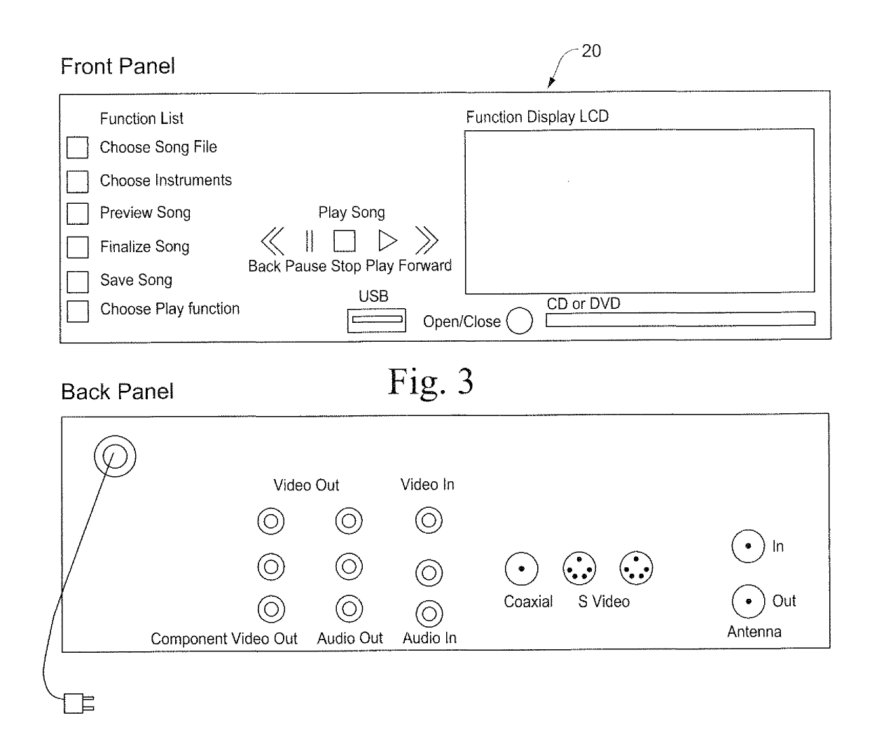

In a computer environment, with reference to FIG. 2, the system may display the exemplary screen shot 10 showing the customization process. As shown in FIG. 3, similar options may be available for a hardware application 20 including an on board processor or the like. Alternatively, the hardware 20 may be connected to a computer or other media processor to perform media customization. With continued reference to FIG. 1, in step S3, the user selects the media such as a song to customize. Once selected, the system displays the performances associated with the selected media, and the user is prompted to select one or more performance tracks (step S4). In this context, in the song example, the user can select one instrumental or vocal performance in each category from multiple performances in each instrumental or vocal category list of the song file. As noted above, the user has the option of choosing multiple performances of the same instrument or vocalist in some song files.

Once the performance tracks have been selected, the user is provided with an option to preview the customized file (step S5). If YES, the system plays the selected tracks as a customized media file (step S6), and subsequently, the user is asked whether any changes are desired (step S7). If so, the process returns to step S4, and the user can select additional performances or deselect previously-selected tracks. If the user indicates that no changes are necessary (NO in step S7) or no preview is desired (NO in step S5), the media file is finalized in step S8. Once finalized, the user can process the finalized media in any suitable format for storage on a computer, CD or other storage device, music player, telephone, etc. (step S9).

As noted above, the system is applicable to any form of media including, without limitation, musical composition, written dialogue, film, etc., with or without sound for a preset number of musicians, vocalists, actors or other visual image mediums such as cartoons, computer generated images, and the like. The system enables a user to customize a particular composition by mixing and matching performers. The system provides unique control for an enhanced listening experience.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of customizing a media composition comprising:
(a) providing a media file with selectable tracks, each track including a recording of a performer performing a part of a particular composition;
(b) providing a user an option to select one or more of the tracks; and
(c) preparing a customized media file based on the user selected tracks.

2. A method according to claim 1, further comprising, prior to step (a), recording the selectable tracks, wherein the selectable tracks of the particular composition are synchronized with one another.

3. A method according to claim 2, wherein the recording step is practiced by recording the selectable tracks in audio isolation with no audio leakage from other tracks.

4. A method according to claim 1, wherein the media file comprises a music file, and wherein step (a) is practiced by providing each track with a recording of a performer playing an instrument or performing a vocal part of the particular composition.

5. A method according to claim 4, wherein step (a) is further practiced by providing the music file with tracks including multiple performances of each instrument or vocal part.

6. A method according to claim 1, further comprising storing the customized media file in a format suitable for download, storage and playback.

7. A method according to claim 1, further comprising, after step (c), enabling the user to preview the customized media file, and providing the user with an option to repeat steps (b) and (c).

8. A method according to claim 7, further comprising, after step (c), finalizing the customized media file upon instruction by the user.

9. A method according to claim 8, further comprising storing the finalized customized media file in a format suitable for download, storage and playback.

10. A media processor for customizing a media file, the media processor comprising:
a processor programmed to carry out a media customization process;
a memory communicating with the processor, the memory storing a media file with selectable tracks, each track including a recording of a performer performing a part of a particular composition; and
a user interface communicating with the processor, the user interface enabling a user to select one or more of the tracks,
wherein the processor is programmed to prepare a customized media file based on the user selected tracks.

11. A media processor according to claim 10, wherein the media file comprises a music file, and wherein the selectable tracks stored in the memory comprise a recording of a performer playing an instrument or performing a vocal part of the particular composition.

12. A media processor according to claim 11, wherein the selectable tracks stored in the memory comprise multiple performances of each instrument or vocal part.

13. A media processor according to claim 10, wherein the selectable tracks of the particular composition are synchronized with one another.

14. A media processor according to claim 10, wherein the media file comprises at least one of an audio file and a video file, and wherein the selectable tracks stored in the memory comprise a recording of a performer playing an instrument, performing a vocal part, or acting.

15. A media processor according to claim 14, wherein the selectable tracks stored in the memory comprise a computer generated or cartoon performance.

16. A method of customizing a media composition comprising:
(a) recording a plurality of media files for the media composition, the media files including digital media tracks synchronized with one another, each track including a recording of a performer performing a part of a particular composition;
(b) providing a user an option to select one or more of the tracks;
(c) combining the selected tracks into a customized media file;
(d) enabling the user to preview the customized media file, and providing the user with an option to repeat steps (b) and (c); and
(e) when prompted by the user, finalizing the customized media file based on the user selected tracks.

17. A method according to claim 16, further comprising storing the finalized customized media file in a format suitable for download, storage and playback.
